(19) United States
(12) Patent Application Publication
(10) Pub. No.: US 2016/0113406 A1
(43) Pub. Date: Apr. 28, 2016

(54) ARM SUPPORT DEVICE AND METHOD OF SUPPORTING ARMS

(71) Applicant: RAVI SHAMAIENGAR, WILLIAMSBURG, VA (US)

(72) Inventor: RAVI SHAMAIENGAR, WILLIAMSBURG, VA (US)

(21) Appl. No.: 14/919,906

(22) Filed: Oct. 22, 2015

Related U.S. Application Data
(60) Provisional application No. 62/066,969, filed on Oct. 22, 2014.

(51) Int. Cl. A47C 7/54; F16M 13/04

(52) U.S. Cl. CPC A47C 7/54; F16M 13/04

(57) ABSTRACT

An arm support device comprises a first loop of a flexible strap, a second loop of a flexible strap, a first cushion covering a portion of the first loop, and a second cushion covering a portion of the second loop. The first loop and the second loop are affixed to each other such that the arm support device has a generally figure eight configuration.

### CROSS-REFERENCE TO RELATED APPLICATIONS

This application claims priority to U.S. Provisional Application Ser. No. 62/066,969, filed Oct. 22, 2014, the contents of which are incorporated herein by reference in its entirety.

### FIELD OF THE INVENTION

The present invention relates generally to arm support devices.

### BACKGROUND

Sitting on an airplane or in a similar confined space can become uncomfortable, especially when sitting for a long time. This is particularly true when you have your arms crossed (or otherwise bent at the elbows) for an extended period of time, which might be necessary when having to share armrests.

### BRIEF SUMMARY

In one embodiment of the invention, an arm support device comprises a first loop of a flexible strap, a second loop of a flexible strap, a first cushion covering a lower portion of the first loop, and a second cushion covering a lower portion of the second loop. The first loop and the second loop are affixed to each other such that the arm support device has a generally figure eight configuration.

The first loop and the second loop may be affixed to each other via a connector. The connector may comprise a swivel connector. The first loop and the second loop may be affixed to each other via stitching.

A first longitudinal channel may be defined through the first cushion and the first strap may pass through the first longitudinal channel such that the first cushion is slidably engaged with the first loop. A second longitudinal channel may be defined through the second cushion and the second strap may pass through the second longitudinal channel such that the second cushion is slidably engaged with the second loop.

The first cushion may be slidably engaged with the first loop and the second cushion may be slidably engaged with the second loop.

The first cushion may be movably engaged with the first loop and the second cushion may be movably engaged with the second loop.

The first cushion may be non-movably affixed to the first loop and the second cushion may be non-movably affixed to the second loop.

The first loop may comprise (i) a first section having a proximal end secured to the second loop and a distal end and (ii) a second section having a proximal end secured to the second loop and a distal end. The distal end of the first section of the first loop and the distal end of the second section of the first loop may be selectively securable to each other. The second loop may comprise (i) a first section having a proximal end secured to the first loop and a distal end and (ii) a second section having a proximal end secured to the first loop and a distal end. The distal end of the first section of the second loop and the distal end of the second section of the second loop are selectively securable to each other. The distal end of the first section of the first loop and the distal end of the second section of the first loop may be selectively securable to each other via a first buckle, and the distal end of the first section of the second loop and the distal end of the second section of the second loop are selectively securable to each other via a second buckle. The distal end of the first section of the first loop and the distal end of the second section of the first loop may be selectively securable to each other via a first hook-and-loop fastener, and the distal end of the first section of the second loop and the distal end of the second section of the second loop are selectively securable to each other via a second hook-and-loop fastener.

The device may further comprise a first selective attachment mechanism affixed to a portion of an outer side of the first loop, a second selective attachment mechanism affixed to a portion of an outer side of the second loop, and a covering garment comprising a first corresponding selective attachment mechanism and a second corresponding selective attachment mechanism. The first selective attachment mechanism of the first loop may be selectively affixable to the first corresponding selective attachment mechanism of the covering garment, and the second selective attachment mechanism of the second loop may be selectively affixable to the second corresponding selective attachment mechanism of the covering garment. The covering garment may comprise a blanket or a shawl.

The device may further comprise a garment comprising a body portion and first and second opposing arm portions, the body portion having a neck hole defined in a top end of the body portion between first and second opposing shoulder portions, a first elongated shoulder opening being defined in the first shoulder portion, a second elongated shoulder opening being defined in the second shoulder portion, a first elongated axillary opening being defined in the body portion below the first arm portion, and a second elongated axillary opening being defined in the body portion below the second arm portion. The first loop extends through the first elongated shoulder opening and the first elongated axillary opening and the second loop extends through the second elongated shoulder opening and the second elongated axillary opening, such that a rear portion of the device is inside the garment and a front portion of the device, including the first cushion and the second cushion, is outside the garment. The garment may comprise a coat, a jacket, or a shirt.

In an alternative embodiment of the invention, a method of supporting a right arm and a left arm of a human comprises (a) obtaining an arm support device, the arm support device comprising a first loop of a flexible strap, a second loop of a flexible strap, the first loop and the second loop being affixed to each other such that the arm support device has a generally figure eight configuration; (b) positioning the arm support device such that a point of affixation of the first and second loops is positioned to rest against a posterior thoracic surface of the human, such that the first loop angles upward and outward from the point of affixation toward a right shoulder of the human and then over the right shoulder, and such that the second loop angles upward and outward from the point of affixation toward a left shoulder of the human and then over the left shoulder; (c) inserting a bent right arm of the human into the first loop and resting a forearm or elbow of the bent right arm on an inside surface of the first loop; and (d) inserting a bent left arm of the human into the second loop and resting a forearm or elbow of the bent left arm on an inside surface of the second loop.

The arm support device further may comprise a first cushion covering a portion of the first loop and a second cushion covering a portion of the second loop. Resting a forearm or elbow of the bent right arm on an inside surface of the first loop may comprise resting a forearm or elbow of the bent right arm on the first cushion. Resting a forearm or elbow of the bent left arm on an inside surface of the second loop may comprise resting a forearm or elbow of the bent left arm on the second cushion.

The arm support device may further comprise a first selective attachment mechanism affixed to a portion of an outer side of the first loop, a second selective attachment mechanism affixed to a portion of an outer side of the second loop, and a covering garment comprising a first corresponding selective attachment mechanism and a second corresponding selective attachment mechanism. The method may further comprise selectively affixing the first selective attachment mechanism of the first loop to the first corresponding selective attachment mechanism of the covering garment, selectively affixing the second selective attachment mechanism of the second loop to the second corresponding selective attachment mechanism of the covering garment, and draping the covering garment around the human. The covering garment may comprise a blanket or a shawl.

The arm support device may further comprise a garment comprising a body portion and first and second opposing arm portions, the body portion having a neck hole defined in a top end of the body portion between first and second opposing shoulder portions, a first elongated shoulder opening being defined in the first shoulder portion, a second elongated shoulder opening being defined in the second shoulder portion, a first elongated axillary opening being defined in the body portion below the first arm portion, and a second elongated axillary opening being defined in the body portion below the second arm portion. The method may further comprise extending the first loop through the first elongated shoulder opening and the first elongated axillary opening and extending the second loop through the second elongated shoulder opening and the second elongated axillary opening, such that a rear portion of the device is inside the garment and a front portion of the device is outside the garment, and placing the garment on the human such that (i) the body portion of the garment at least partially surrounds a torso of the human, (ii) the right arm of the human is in the first arm portion of the garment, and (iii) the left arm of the human is in the second arm portion of the garment. The garment may comprise a coat, a jacket, or a shirt.

In an alternative embodiment of the invention, an arm support system comprises an arm support device and a covering garment comprising a first corresponding selective attachment mechanism and a second corresponding selective attachment mechanism. The arm support device comprises a first loop of a flexible strap with a first selective attachment mechanism being affixed to a portion of an outer side of the first loop, a second loop of a flexible strap with a second selective attachment mechanism being affixed to a portion of an outer side of the second loop, the first loop and the second loop being affixed to each other such that the arm support device has a generally figure eight configuration, a first cushion covering a lower portion of the first loop, and a second cushion covering a lower portion of the second loop. The first selective attachment mechanism of the first loop is selectively affixable to the first corresponding selective attachment mechanism of the covering garment. The second selective attachment mechanism of the second loop is selectively affixable to the second corresponding selective attachment mechanism of the covering garment. The covering garment may comprise a blanket or a shawl.

In an alternative embodiment of the invention, an arm support system comprises an arm support device and a garment comprising a body portion and first and second opposing arm portions, the body portion having a neck hole defined in a top end of the body portion between first and second opposing shoulder portions, a first elongated shoulder opening being defined in the first shoulder portion, a second elongated shoulder opening being defined in the second shoulder portion, a first elongated axillary opening being defined in the body portion below the first arm portion, and a second elongated axillary opening being defined in the body portion below the second arm portion. The arm support device comprises a first loop of a flexible strap, a second loop of a flexible strap, the first loop and the second loop being affixed to each other such that the arm support device has a generally figure eight configuration, a first cushion covering a lower portion of the first loop, and a second cushion covering a lower portion of the second loop. The first loop extends through the first elongated shoulder opening and the first elongated axillary opening and the second loop extends through the second elongated shoulder opening and the second elongated axillary opening, such that a rear portion of the device is inside the garment and a front portion of the device, including the first cushion and the second cushion, is outside the garment. The garment may comprise a coat, a jacket, or a shirt.

BRIEF DESCRIPTION OF THE SEVERAL VIEWS OF THE DRAWING(S)

Reference is made herein to the accompanying drawings, which are not necessarily drawn to scale, and wherein:

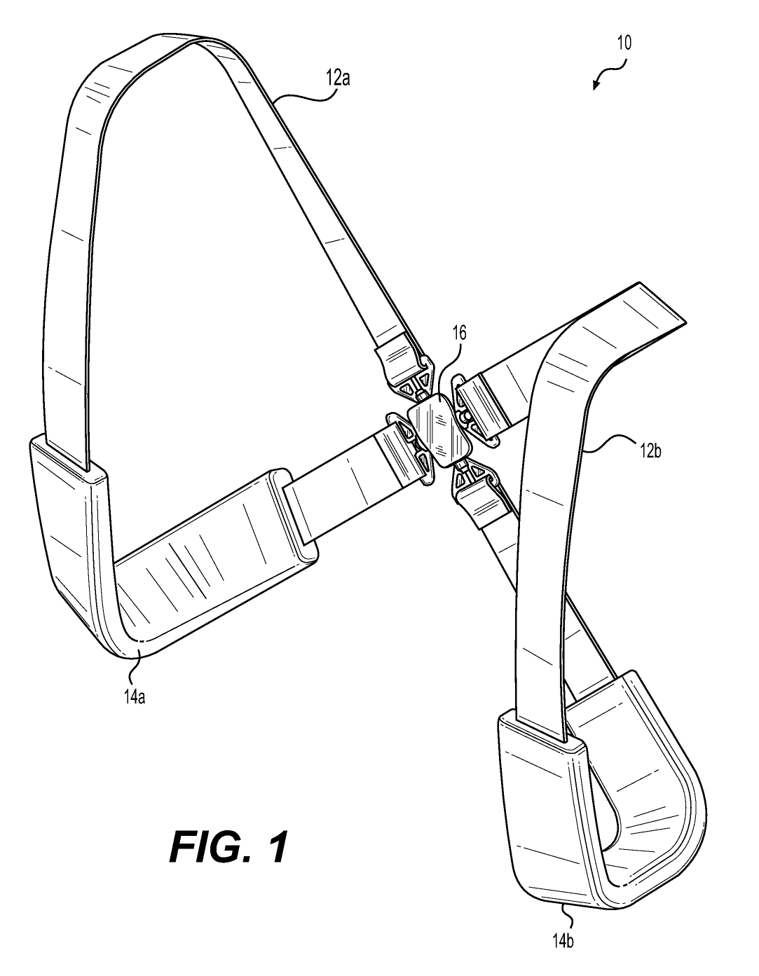

FIG. 1 is a perspective view of an arm support device, from the front and top, in accordance with embodiments of the invention.

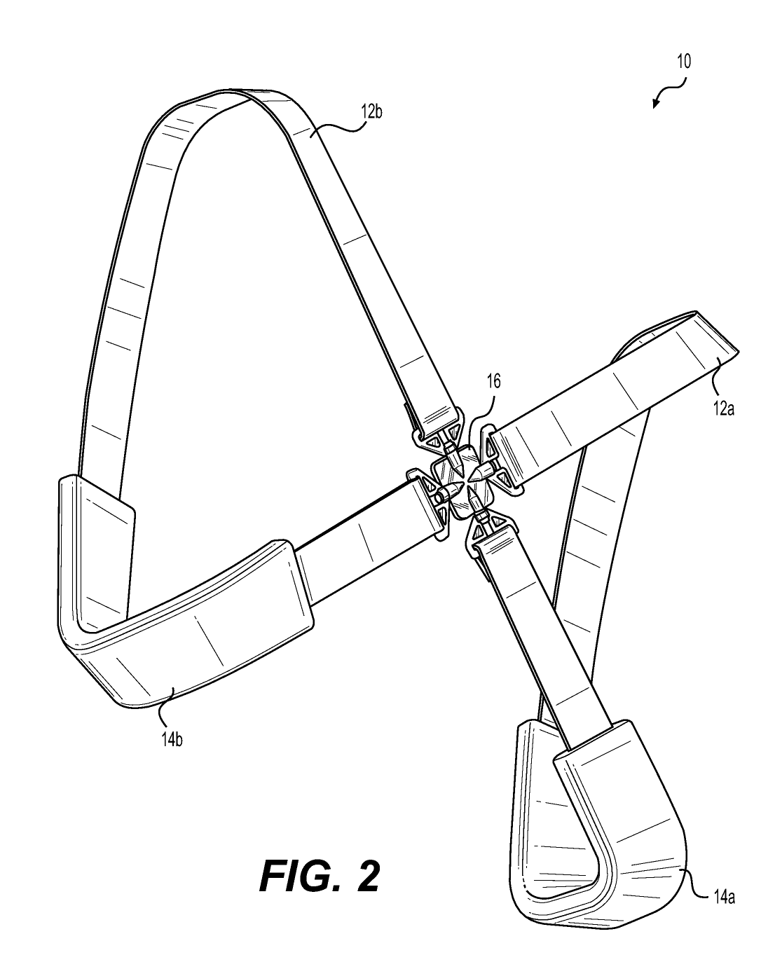

FIG. 2 is a perspective view of the arm support device of FIG. 1, from the rear and bottom.

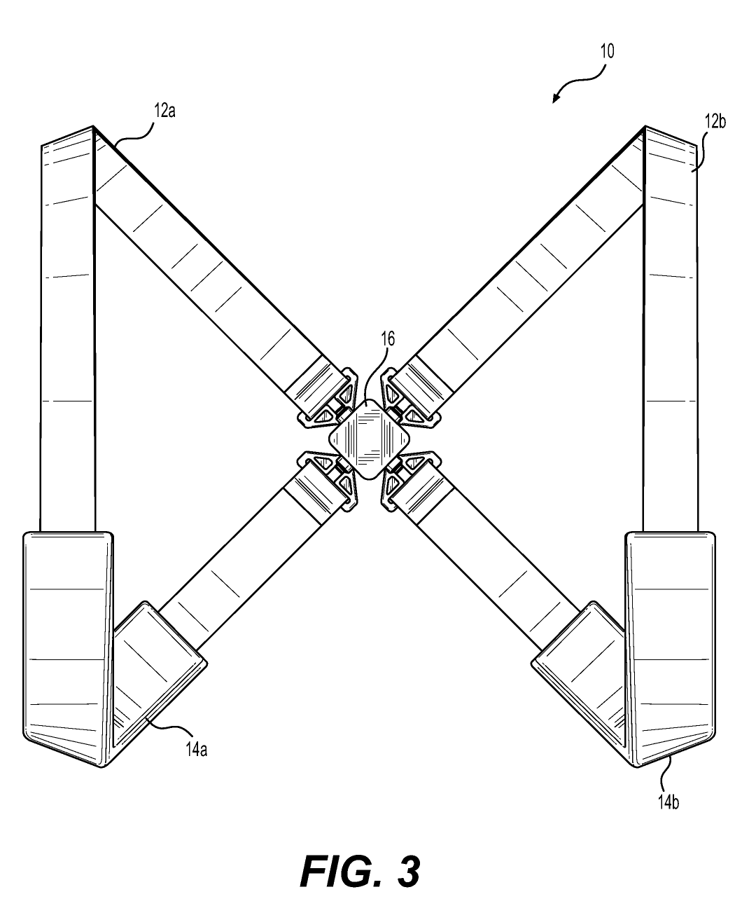

FIG. 3 is a front view of the arm support device of FIG. 1.

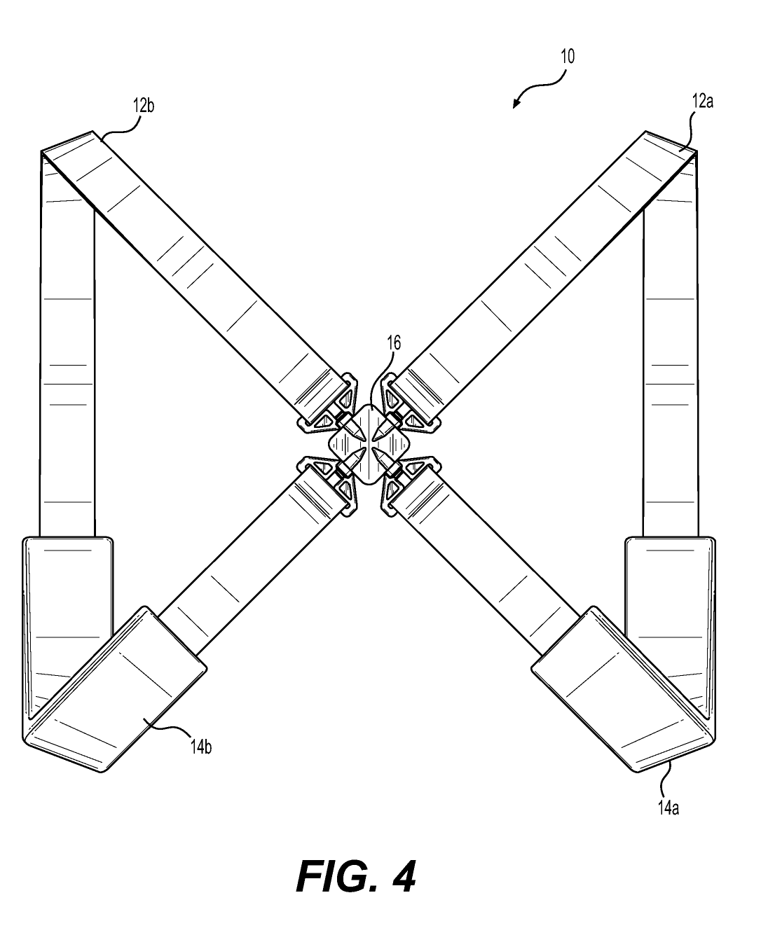

FIG. 4 is a rear view of the arm support device of FIG. 1.

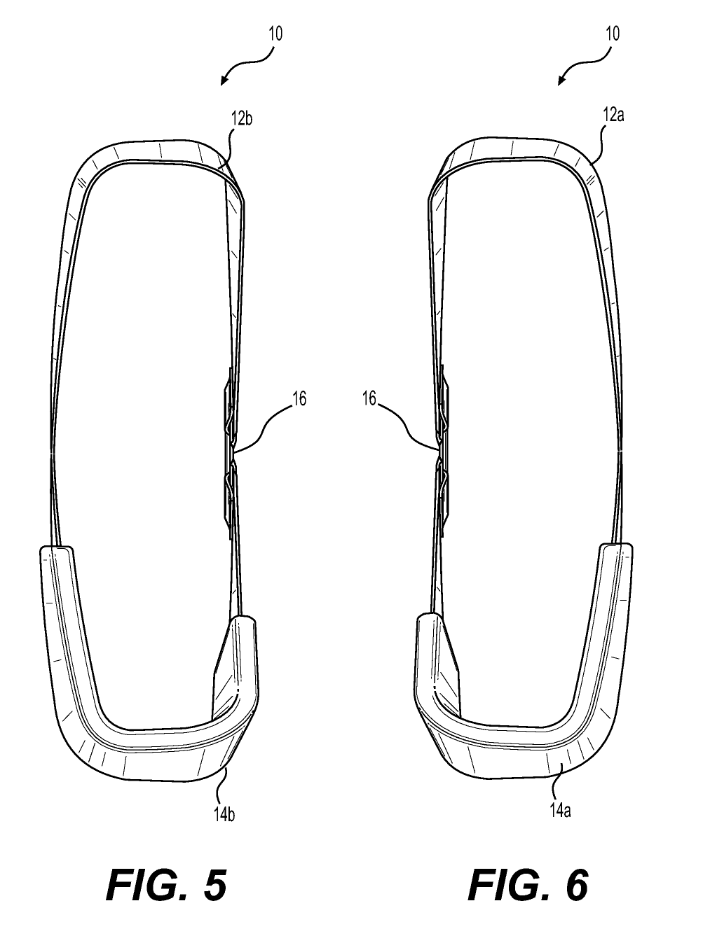

FIG. 5 is a left side view of the arm support device of FIG. 1.

FIG. 6 is a right side view of the arm support device of FIG. 1.

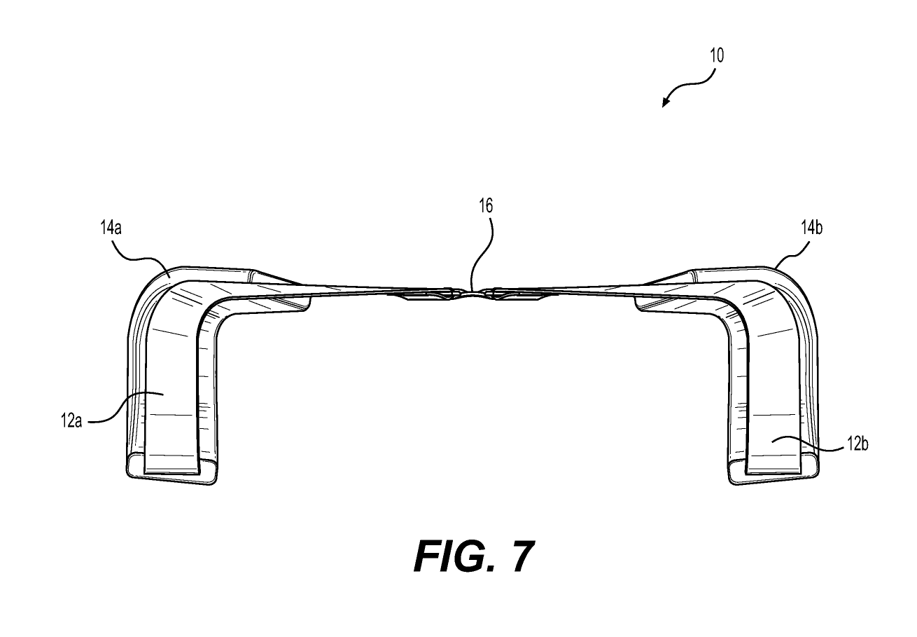

FIG. 7 is a top view of the arm support device of FIG. 1.

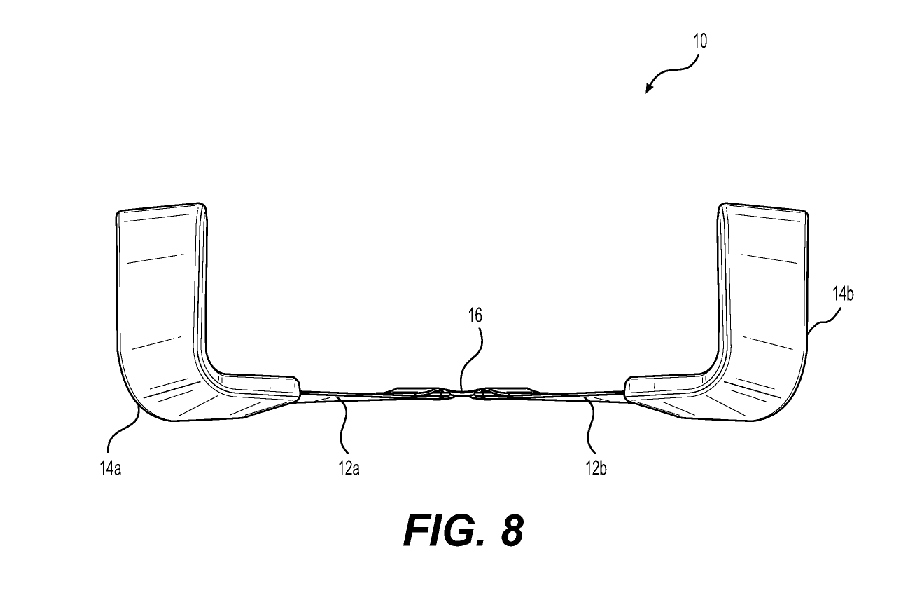

FIG. 8 is a bottom view of the arm support device of FIG. 1.

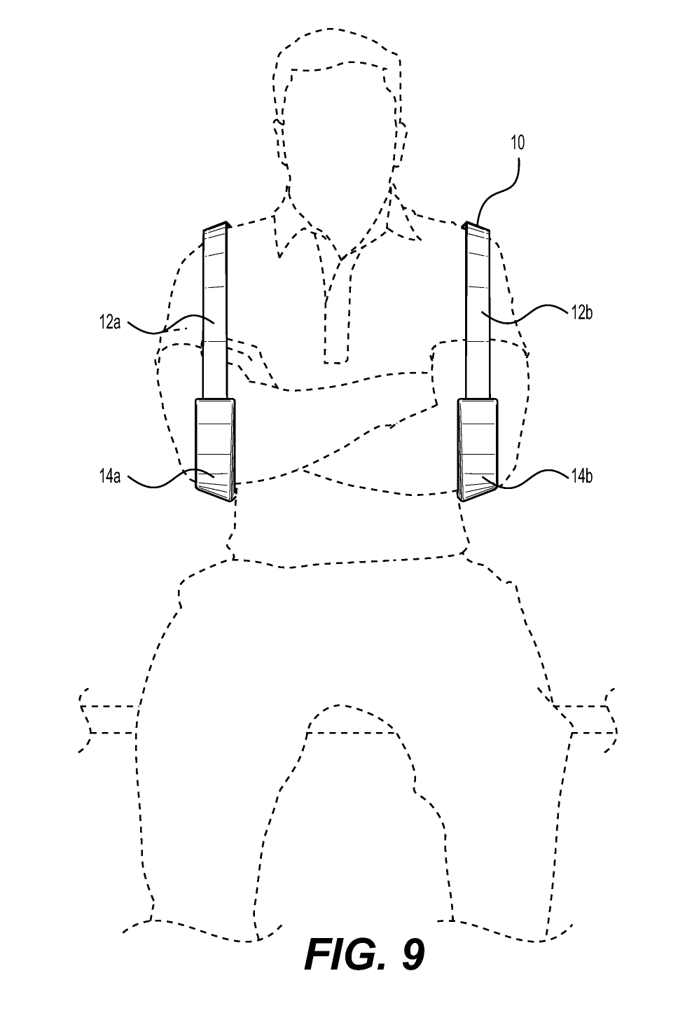

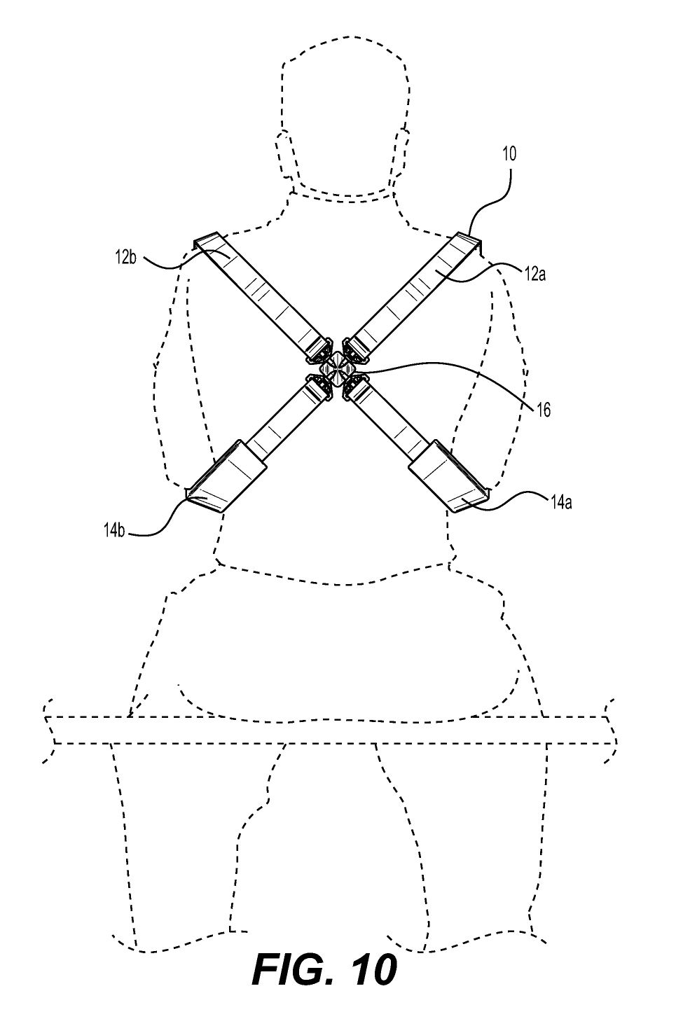

FIG. 9 is a front view of a user wearing the arm support device of FIG. 1.

FIG. 10 is a rear view of a user wearing the arm support device of FIG. 1.

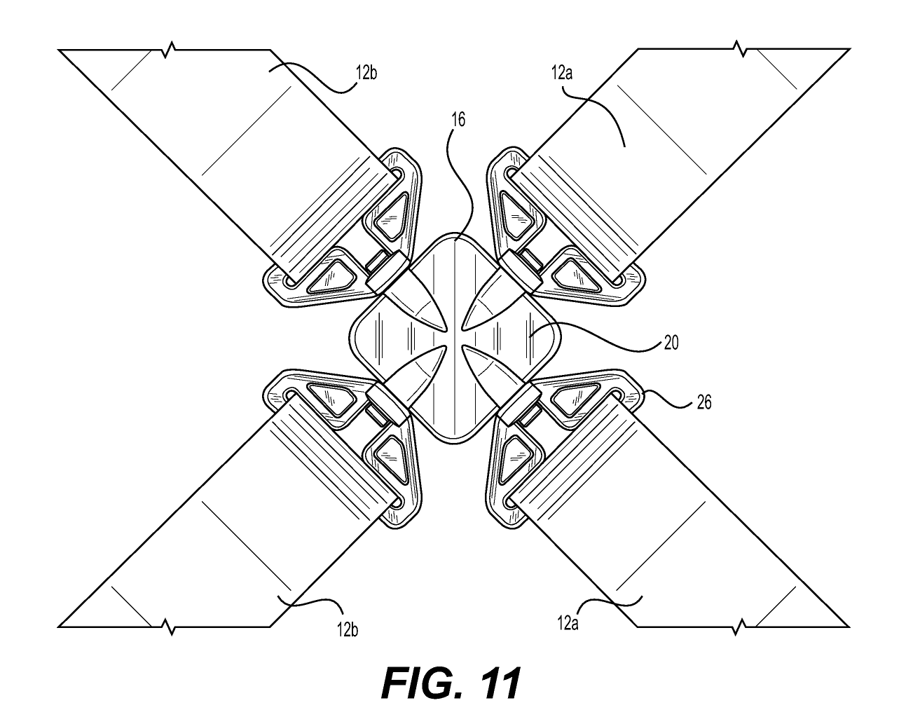

FIG. 11 is a close up rear view of a portion of the arm support device of FIG. 1.

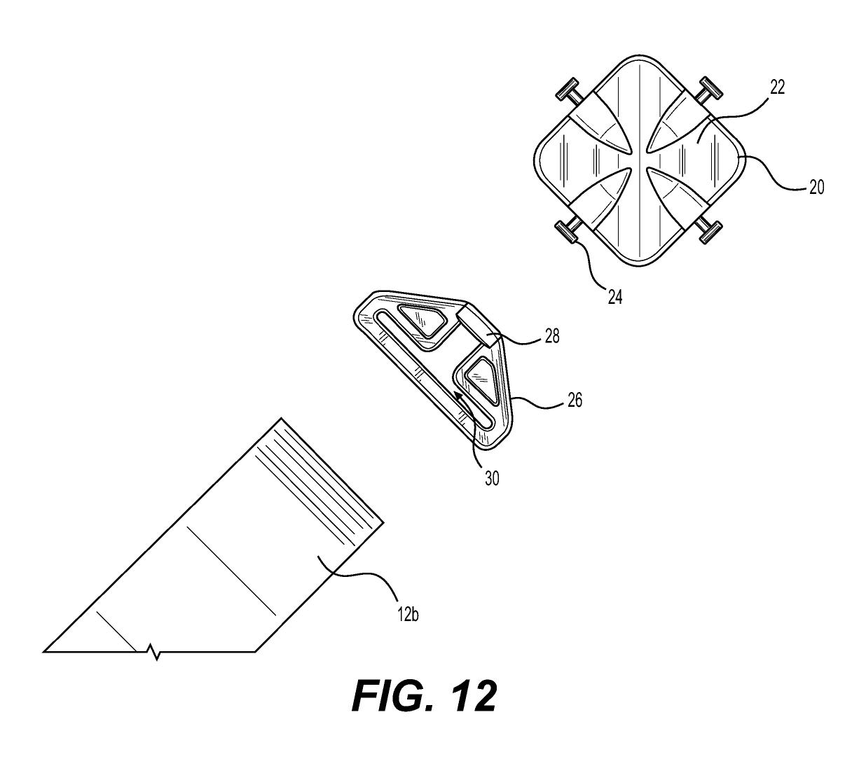

FIG. 12 is an exploded view of a portion of the arm support device of FIG. 1.

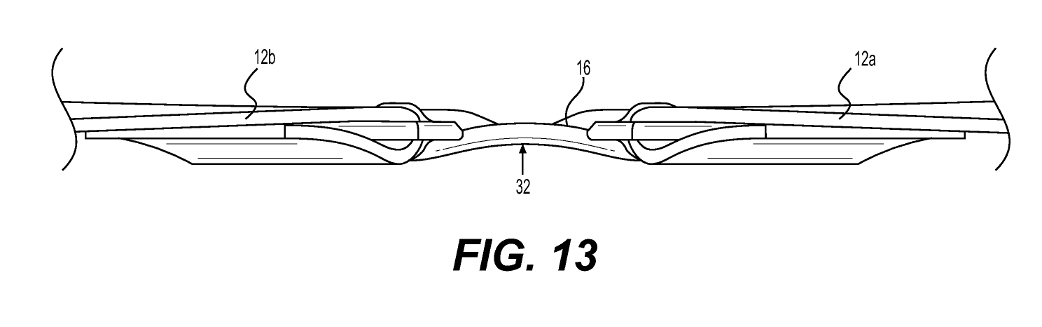

FIG. 13 is a close up bottom view of a portion of the arm support device of FIG. 1.

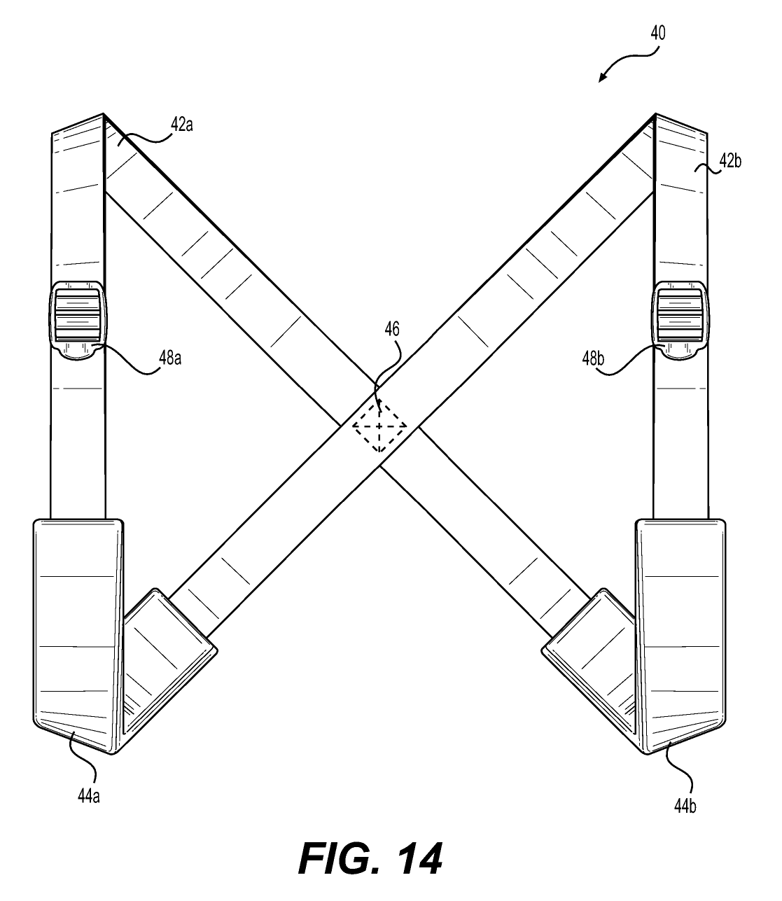

FIG. 14 is a front view of an arm support device, in accordance with alternative embodiments of the invention.

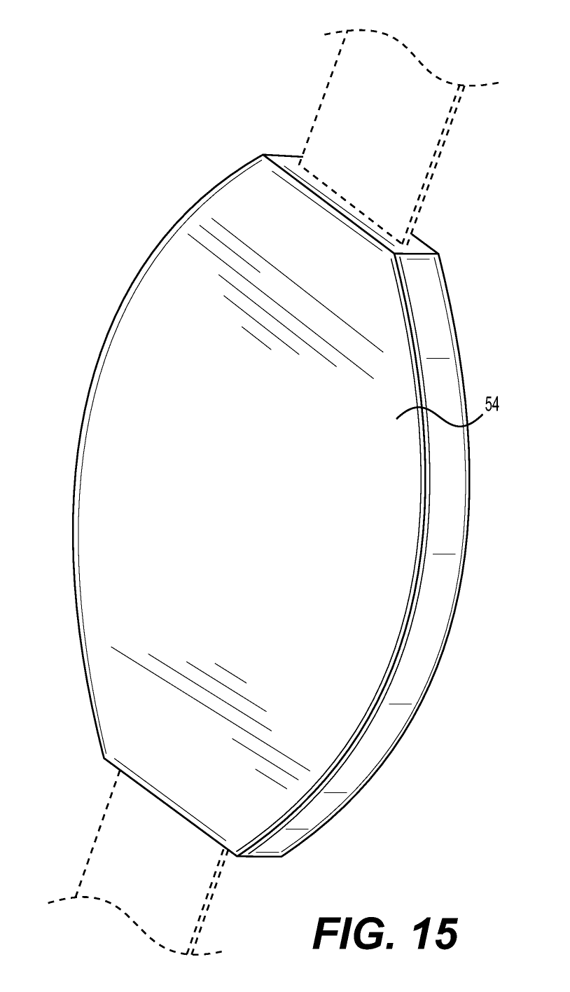

FIG. 15 is a close up perspective view of an alternative padded cushion of an arm support device, in accordance with alternative embodiments of the invention.

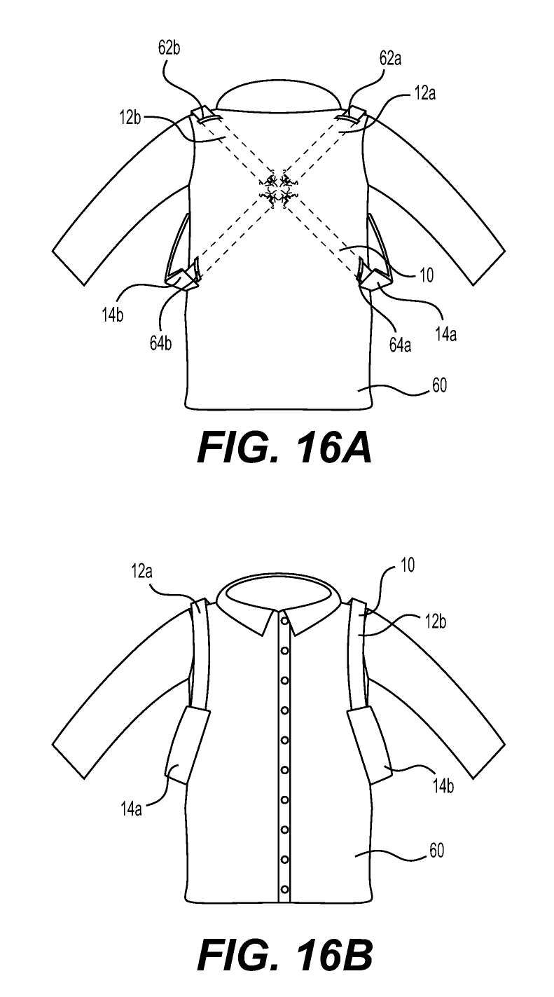

FIGS. 16 A and 16B are rear and front views, respectively, of a garment used in conjunction with the arm support device of FIG. 1.

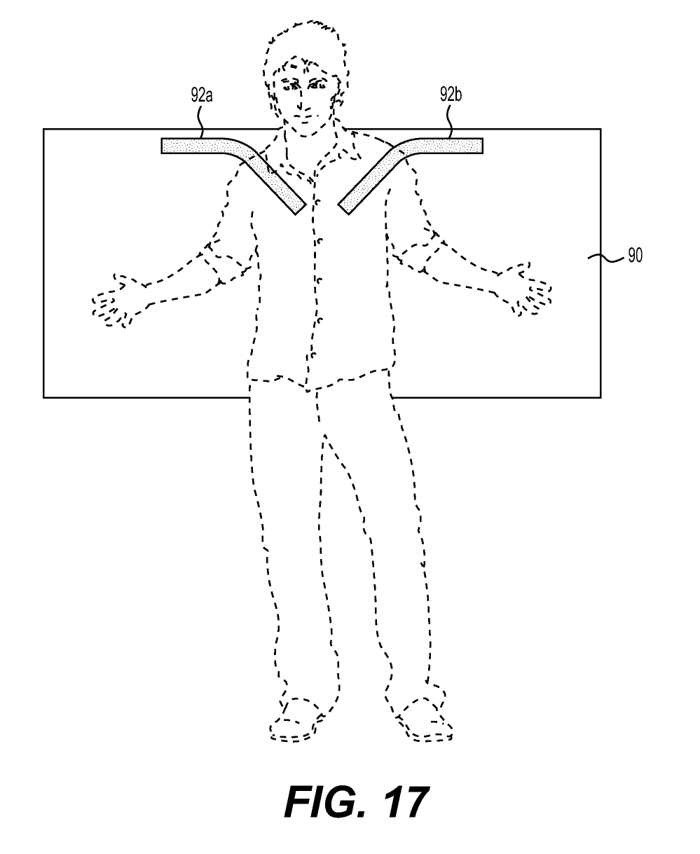

FIG. 17 is a front view of a blanket used in conjunction with an arm support device, in accordance with alternative embodiments of the invention.

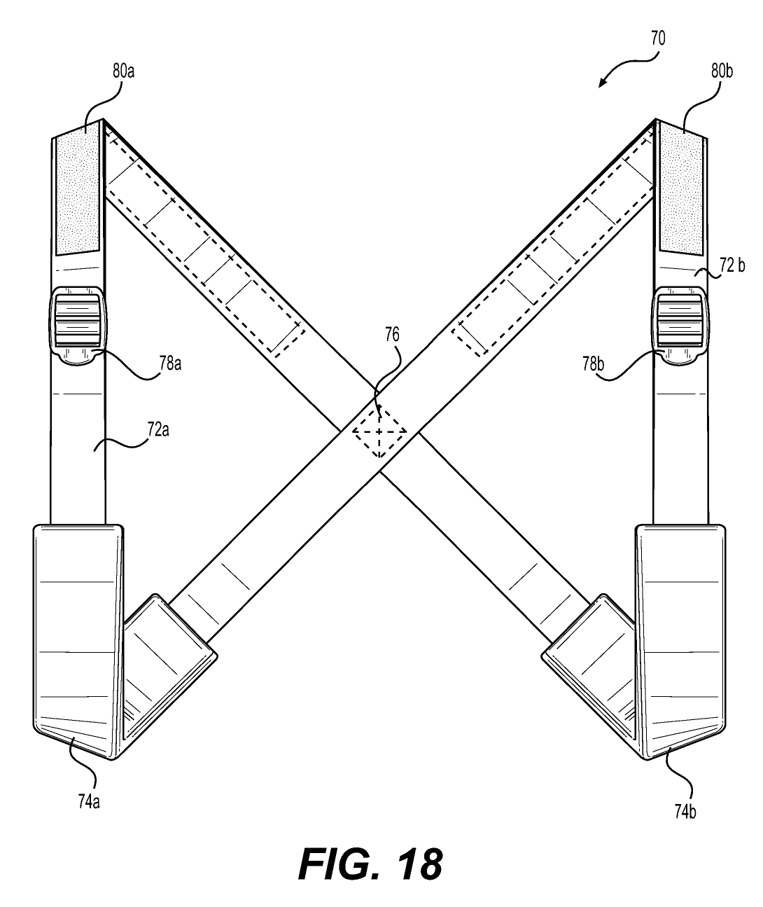

FIG. 18 is a front view of an arm support device for use in conjunction with the blanket of FIG. 17.

### DETAILED DESCRIPTION

Certain terminology is used in the following description for convenience only and is not limiting. The words “right,” “left,” “lower,” “bottom,” “upper,” and “top” designate directions in the drawings to which reference is made. The words “leftward,” “rightward,” “inward,” “outward,” “up,” “upward,” “down,” and “downward” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the invention comprise devices and methods for supporting a person's arms. The devices and methods of embodiments of the invention help support or hold up the person's arms when the person's arms are bent at the elbow (such as when the arms are crossed, as seen in FIGS. 9 and 10). The support provided by the devices and methods of embodiments of the invention transfer some of the weight of the arms from the person's shoulders to the person's back, thereby relieving stress and strain on the person's shoulders which makes sitting more comfortable and less physically stressful.

Referring now to FIGS. 1-10, an arm support device 10 of embodiments of the invention comprises a right looped strap 12a and a left looped strap 12b. Each end of each strap 12a, 12b is joined to a connector 16 (described further below). A right padded cushion 14a is slidably engaged with (or alternatively affixed to) the right strap 12a, and a left padded cushion 14b is slidably engaged with (or alternatively affixed to) the left strap 12b. The padded cushions 14a, 14b provide cushioning at the point of arm support for additional user comfort.

When worn, the connector rests against the user's back (generally over the user's spine) and the straps at the back of the device form an X shape (as seen in FIGS. 3 and 4). The right strap 12a angles upward and outward from the connector 16 toward the user's right shoulder and then over the user's right shoulder, with the right strap being in contact with the user's back and right shoulder. The right strap 12a angles downward from the user's shoulder and loops under the user's right arm (when the user's arm is engaged with the device), around the right side of the user's torso, and upward and inward to the connector 16, thereby forming a right side cupped or generally U-shaped portion (best seen in FIGS. 5 and 6). The user's right elbow and/or forearm rests in the right side cupped portion, as seen in FIG. 9.

Similarly, the left strap 12b angles upward and outward from the connector 16 toward the user's left shoulder and then over the user's left shoulder, with the left strap being in contact with the user's back and left shoulder. The left strap 12b angles downward from the user's shoulder and loops under the user's left arm (when the user's arm is engaged with the device), around the left side of the user's torso, and upward and inward to the connector 16, thereby forming a left side cupped or generally U-shaped portion (best seen in FIGS. 5 and 6). The user's left elbow and/or forearm rests in the left side cupped portion, as seen in FIG. 9.

While embodiments of the invention are described herein in reference to a user's shoulder, such use of the word “shoulder” is meant to refer to the area of a human body between the upper arm and the neck, rather than a more specific or limited medical definition (e.g., the junction of the clavicle, scapula, and humerus where the arm attaches to the trunk of the body). In use, the straps 12a, 12b may rest on the user's shoulder in a position closer to the upper arm, closer to the neck, or midway therebetween.

The straps 12a, 12b may be constructed out of any suitably strong yet flexible material or blend of materials, including but not limited to nylon webbing.

The padded cushions 14a, 14b may comprise an outer envelope containing a padding material. The outer envelope may be constructed out of any suitably strong yet flexible (and preferably soft) material or blend of materials, including but not limited to nylon, spandex/elastane (such as Lycra), fleece (natural or synthetic, such as polar fleece), or polyester (including microfiber polyester). Any suitable padding material may be used, such as foam or batting. In the illustrated embodiments of the invention, the padded cushions 14a, 14b have a generally rectangular shape. In alternative embodiments of the invention, other shapes may be used. For example, the long edges of the padded cushions may curve outward such that the padded cushions are generally round or have a “football” shape. One example of such a “football” shape is padded cushion 54 illustrated in FIG. 15. Such outward curvature of the long edges of the padded cushions provides a larger support surface and therefore provides additional support for the user's arms.

In the illustrated embodiments of the invention, the padded cushions 14a, 14b have a longitudinal channel defined therethrough, and each of the straps 12a, 12b passes through the channel of a respective one of the padded cushions. In this regard, each padded cushion 14a, 14b may be slidably movable along its respective strap, thereby enabling the relative position of each of the padded cushion 14a, 14b to be adjusted by the user to ensure that the padded cushions are positioned as desired relative to the user's arms. In the illustrated embodiment, the longitudinal channel is illustrated as being approximately in the center of the padded cushions, such that there are roughly equal amounts of padding on both sides of the straps. In alternative embodiments of the invention, the longitudinal channel may be off-center in the padded cushions (typically toward the outside), such that most or all of the padding is on the side of the straps toward the user's arms. The cushions may also alternatively be slidably engaged with the straps 12a, 12b via loops or straps affixed to the side of the cushions opposite the user's arms. Alternatively, the cushions may be movably affixed to the straps 12a, 12b, such as via hook-and-loop fasteners which allow the cushions to be repositioned but keep the cushions fixed in place during use. Yet further alternatively, the cushions may be removably affixed to the straps 12a, 12b, such as via snaps. In alternative embodiments of the invention, the padded cushions may be immovably affixed (e.g., sewn) to the straps.

Referring now to FIGS. 11-13, the connector 16 is described in more detail. Connector 16 has a center portion 20 and swiveling buckles 26. The center portion 20 has a generally square main body 22 (although many other shapes could be used, such as circular or X-shaped) and four pins 24 that each project outward from a respective side of the main body 22. The pins 24 each comprise a circular flat head portion at the distal end of a cylindrical post portion. Each one of the swiveling buckles 26 is affixed to a respective one of the pins 24. Each swiveling buckle 26 comprises an attachment point 28 that defines a through-hole into which a respective one of the pins 24 is inserted. Once inserted, the head portion of the pin cannot easily be pulled back out of the through-hole, such that the swiveling buckle 26 remains affixed to the center portion 20. Each swiveling buckle 26 defines an elongated slot 30. Each end of each strap 12a, 12b is affixed to a respective one of the swiveling buckles 26 via the elongated slot 30. During construction of the device, a respective end of a strap is inserted through a respective slot 30, folded back upon itself, and secured (e.g., sewn) to itself, thereby securely affixing the straps to the swiveling buckles. The side 32 of main body 22 that rests against a user's back is curved so as to more comfortably rest against the user's spine. This curvature is seen in the close-up bottom view of FIG. 13.

The swiveling nature of the connector 16 enables the straps 12a, 12b to move somewhat in order for the device to adjust to the shape and contour of the user's body. Any suitable self-adjusting connector may be used. In an alternative embodiment of the invention illustrated in FIG. 14, an arm support device 40 comprises a right looped strap 42a and a left looped strap 42b. A right padded cushion 44a is slidably engaged with (or alternatively affixed to) the right strap 42a, and a left padded cushion 44b is slidably engaged with (or alternatively affixed to) the left strap 42b. In contrast to device 10 described above, the straps 42a, 42b are affixed (e.g., sewn) to each other at attachment point 46. In such an alternative embodiment, the movement and self-adjustability of the device comes from the flexible nature of the straps 42a, 42b.

Also in the alternative embodiment of the invention illustrated in FIG. 14, the straps 42a, 42b of the arm support device 40 are not continuous in the front but rather comprise two separate portions that are joined by buckles 48a, 48b. Buckles 48a, 48b enable to lengths of straps 42a, 42b to be adjustable to better fit different size users. Buckles 48a, 48b are illustrated as ladder buckles, but any suitable type of buckle may be used.

The illustrated embodiments of the invention are shown as independent devices that a user would don over his/her clothes. In alternative embodiments of the invention, the arm support device may be incorporated into or otherwise used with a garment, such as a shirt, vest, poncho or coat, or a blanket, or the like. Referring now to FIGS. 16 A and 16B, rear and front views are illustrated, respectively, of a garment (in this example, the garment is a coat) used in conjunction with an arm support device of embodiments of the invention. The garment 60 may be used with the arm support device 10 of FIG. 1, or may be used with alternative arm support devices of embodiments of the invention. The garment 10 may be nearly identical to a standard coat, but with elongated openings or slits to accommodate the straps of the arm support device. Specifically, there is a right shoulder slit 62a, a left shoulder slit 62b, a right axillary slit 64a, and a left axillary slit 64b. The shoulder slits 62a, 62b are typically located along the middle top of the shoulder (although may be anterior or posterior of the top of the shoulder as needed, and/or left or right of the middle as needed) and generally parallel to the anatomical coronal plane of the user when worn (although may be angled from parallel as needed). The axillary slits 64a, 64b are generally vertical (although may be angled from vertical as needed) and typically about 1-3 inches posterior of the mid-axillary line of the user when worn (although may be anterior or posterior of that location as needed). The slits are typically slightly longer than the width of the straps of the arm support device and slightly wider than the thickness of the straps of the arm support device, such that the straps of the arm support are easily threaded through the slits but such that the straps are relatively snug within the slits so that there is not excessive movement of the straps within the slits once in place.

As seen in FIGS. 16A and 16B, the straps 12a, 12b of the arm support device are threaded through the slits such that the rear portion of the arm support device (where the straps meet and are affixed to each other) is under the garment when worn by the user and such that the front portion of the arm support device, including the padded cushions 14a, 14b, are outside the garment when worn by the user. In this regard, the user is able to rest his/her arms in the cushions while wearing the garment, and the arm support device stays in place and does not, e.g., slide off the user's shoulders.

In alternative embodiments of the invention, the arm support device may be removably or non-removably affixed to the garment. For example, portions of the inside back of the garment and corresponding portions of the outside surface of the straps of the back portion of the arm support device may have corresponding mechanisms (e.g., hook-and-loop fastener) to be removably affixed together. As another example, portions of the outside surface of the straps of the back portion of the arm support device may be sewn to the inside back of the garment.

The garment for use with an arm support device of embodiments of the invention may also be a covering garment which is adapted to be draped over the shoulders of and wrapped around a user, such as a blanket, shawl, or the like. Referring now to FIG. 17, a front view of a blanket used in conjunction with an arm support device is illustrated in accordance with alternative embodiments of the invention. As seen in FIG. 17, the blanket 90 has right and left fastening mechanisms 92a, 92b for removably affixing an arm support device to the blanket. The right and left fastening mechanism 92a, 92b are affixed to the blanket and positioned such that the straps of the arm support device will be properly positioned at the user's back and over the user's shoulders when the arm support device is affixed to the blanket and when the blanket is wrapped around the user's back and draped over the user's shoulders. A dashed line outline of a user is shown in FIG. 17 to illustrate the relative position of the right and left fastening mechanism.

FIG. 18 is a front view of an arm support device for use in conjunction with the blanket of FIG. 17 or a similar garment, cloak, poncho, etc. Arm support device 70 of FIG. 18 is similar to the arm support device of FIG. 14, in that arm support device 70 comprises a right looped strap 72a, a left looped strap 72b, a right padded cushion 74a slidably engaged with (or alternatively affixed to) the right strap 72a, and a left padded cushion 74b slidably engaged with (or alternatively affixed to) the left strap 72b. The straps 72a, 72b may be affixed (e.g., sewn) to each other at attachment point 76 as illustrated, or may be joined to each other with a connector such as connector 16 in FIG. 1. The straps 72a, 72b of the arm support device 70 may comprise two separate portions that are joined by buckles 78a, 78b, as illustrated, or such buckles may be omitted as in the arm support device of FIG. 1.

Additionally, arm support device 70 of FIG. 18 has right and left fastening mechanisms 80a, 80b for removably affixing the arm support device 70 to the blanket 90 of FIG. 17 or the like. The right and left fastening mechanisms 80a, 80b respectively correspond to and are removably affixable to the right and left fastening mechanisms 92a, 92b of the blanket 90 (or the like). The right and left fastening mechanisms 80a, 80b are located on the outer side of the straps 72a, 72b (i.e., the side of the straps away from the user when worn). The right and left fastening mechanisms 80a, 80b are typically located on the portions of the straps 72a, 72b that are positioned over the user's shoulders and part way down the user's back (typically not all the way down to the attachment point 76) when the arm support device is worn by the user.

The right and left fastening mechanisms 80a, 80b of the arm support device 70 and the corresponding right and left fastening mechanisms 92a, 92b of the blanket 90 may comprise, e.g., hook-and-loop fasteners.

When arm support device 70 of FIG. 18 is affixed to blanket 90 of FIG. 17 (or the like), blanket 90 may be wrapped around the user's back and draped over the user's shoulders for warmth, and the user may place his/her arms in the arm support device 70 for support.

In accordance with embodiments of the invention, methods of supporting arms may comprise donning an arm support device as described above and placing one's arms into the cupped or generally U-shaped portion as shown in FIGS. 9 and 10.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. An arm support device comprising:
a first loop of a flexible strap;
a second loop of a flexible strap, the first loop and the second loop being affixed to each other such that the arm support device has a generally figure eight configuration;
a first cushion covering a lower portion of the first loop; and
a second cushion covering a lower portion of the second loop.

2. The device of claim 1, wherein the first loop and the second loop are affixed to each other via a connector.

3. The device of claim 2, wherein the connector comprises a swivel connector.

4. The device of claim 1, wherein the first loop and the second loop are affixed to each other via stitching.

5. The device of claim 1, wherein a first longitudinal channel is defined through the first cushion and the first strap passes through the first longitudinal channel such that the first cushion is slidably engaged with the first loop; and
wherein a second longitudinal channel is defined through the second cushion and the second strap passes through the second longitudinal channel such that the second cushion is slidably engaged with the second loop.

6. The device of claim 1, wherein the first cushion is slidably engaged with the first loop and the second cushion is slidably engaged with the second loop.

7. The device of claim 1, wherein the first cushion is movably engaged with the first loop and the second cushion is movably engaged with the second loop.

8. The device of claim 1, wherein the first cushion is non-movably affixed to the first loop and the second cushion is non-movably affixed to the second loop.

9. The device of claim 1, wherein the first loop comprises (i) a first section having a proximal end secured to the second loop and a distal end and (ii) a second section having a proximal end secured to the second loop and a distal end;
wherein the distal end of the first section of the first loop and the distal end of the second section of the first loop are selectively securable to each other;
wherein the second loop comprises (i) a first section having a proximal end secured to the first loop and a distal end and (ii) a second section having a proximal end secured to the first loop and a distal end; and
wherein the distal end of the first section of the second loop and the distal end of the second section of the second loop are selectively securable to each other.

10. The device of claim 9, wherein the distal end of the first section of the first loop and the distal end of the second section of the first loop are selectively securable to each other via a first buckle; and
wherein the distal end of the first section of the second loop and the distal end of the second section of the second loop are selectively securable to each other via a second buckle.

11. The device of claim 9, wherein the distal end of the first section of the first loop and the distal end of the second section of the first loop are selectively securable to each other via a first hook-and-loop fastener; and
wherein the distal end of the first section of the second loop and the distal end of the second section of the second loop are selectively securable to each other via a second hook-and-loop fastener.

12. The device of claim 1, further comprising:
a first selective attachment mechanism affixed to a portion of an outer side of the first loop;
a second selective attachment mechanism affixed to a portion of an outer side of the second loop; and
a covering garment comprising a first corresponding selective attachment mechanism and a second corresponding selective attachment mechanism;
wherein the first selective attachment mechanism of the first loop is selectively affixable to the first corresponding selective attachment mechanism of the covering garment; and
wherein the second selective attachment mechanism of the second loop is selectively affixable to the second corresponding selective attachment mechanism of the covering garment.

13. The device of claim 12, wherein the covering garment comprises a blanket or a shawl.

14. The device of claim 1, further comprising:
a garment comprising a body portion and first and second opposing arm portions, the body portion having a neck hole defined in a top end of the body portion between first and second opposing shoulder portions, a first elongated shoulder opening being defined in the first shoulder portion, a second elongated shoulder opening being defined in the second shoulder portion, a first elongated axillary opening being defined in the body portion below the first arm portion, and a second elongated axillary opening being defined in the body portion below the second arm portion;
wherein (i) the first loop extends through the first elongated shoulder opening and the first elongated axillary opening and (ii) the second loop extends through the second elongated shoulder opening and the second elongated axillary opening, such that a rear portion of the device is inside the garment and a front portion of the device, including the first cushion and the second cushion, is outside the garment.

15. The device of claim 14, wherein the garment comprises a coat, a jacket, or a shirt.
